(19) United States
(12) Patent Application Publication
(10) Pub. No.: US 2014/0000529 A1
(43) Pub. Date: Jan. 2, 2014

(54) Pet Food with Auditory Stimulus

(71) Applicant: The lams Company, Cincinnati, OH (US)

(72) Inventors: Gregory Dean Sunvold, Lewisburg, OH (US); Jeffrey Douglas Metzner, Fayetteville, AR (US)

(21) Appl. No.: 13/930,891

(22) Filed: Jun. 28, 2013

Related U.S. Application Data
(60) Provisional application No. 61/666,139, filed on Jun. 29, 2012.

(51) Int. Cl. A01K 15/02

(52) U.S. Cl. CPC A01K 15/02
USPC 119/702; 119/719; 206/524.6

(57) ABSTRACT

A pet food may be packaged in a container having at least one rigid, metallic wall. When shaken, the pet food may strike the rigid, metallic wall, creating a unique auditory stimulus that is appealing to many pets. The pet food may be a routine diet, a treat, or a supplement, and may be dry or semi-moist.

### FIELD OF THE INVENTION

This disclosure relates generally to pet foods, such as edible pet treats in a package or container that produces a unique auditory stimulus.

### BACKGROUND OF THE INVENTION

Pet foods for companion animals, such as dogs and cats, include routine diets, treats, and supplements. Pet foods are often packaged in a bag, the bag comprising paper and/or polymer components. Alternative packaging includes trays, cups, cans, pouches, jars, and tins. The packaging is often selected to maintain or preserve the food inside.

Packaging may also be designed for the convenience of the owner or caretaker of the animal for whom the food is intended. For example, cans or tins may have pull-away lids that do not require a can-opener, and packages of many types may have re-sealing features to facilitate storing any portion of the package contents which are not immediately used upon opening the package.

There remains a need for a pet food in a package designed for the experience of the animal for whom the food is intended.

### SUMMARY OF THE INVENTION

In some aspects, the disclosure relates to a pet food product. The pet food product may comprise a container. The container may comprise at least one rigid, metallic wall. The pet food product may comprise two or more distinct pieces of pet food. The two or more distinct pieces of pet food may be moveably disposed inside the container. The container may comprise at least two rigid metallic walls. The container may comprise exactly one rigid, metallic wall. The rigid, metallic wall may be integral to the container. The rigid, metallic wall may be reversibly removable from the container. The rigid, metallic wall may be irreversibly removable from the container.

The pet food may be a treat or supplement. The pet food may be a nutritionally balanced diet. The container may comprise approximately 1 meal's worth of pet food. The pet food may be semi-moist. The pet food may be dry. The pet food may occupy no more than 60% of the volume of the container. The pet food may comprise parsley, rosemary, thyme, oregano, sage, or combinations thereof. The pet food may comprise a prebiotic, a probiotic, a bacteriophage, a dental plaque preventative, mannoheptulose, an antioxidant, a caloric restriction mimetic, a polyphenol, an isoflavone, or a combination thereof. The pet food may comprise an oligosaccharide.

The pet food may be filled into the container to leave at least 1.3 cm of headspace at the top of the container. The pet food may be filled into the container to leave at least 2.5 cm of headspace at the top of the container.

A method of attracting a pet's attention may comprise shaking a pet food product. The pet food product may comprise a container. The container may comprise at least one rigid, metallic wall. The pet food product may comprise two or more distinct pieces of pet food. The two or more distinct pieces of pet food may be moveably disposed inside the container.

A method of summoning a pet may comprise shaking a pet food product. The pet food product may comprise a container. The container may comprise at least one rigid, metallic wall. The pet food product may comprise two or more distinct pieces of pet food. The two or more distinct pieces of pet food may be moveably disposed inside the container.

A method of training a pet may comprise inducing or observing a desired pet behavior. The method may comprise shaking a pet food product. The pet food product may comprise a container. The container may comprise at least one rigid, metallic wall. The pet food product may comprise two or more distinct pieces of pet food. The two or more distinct pieces of pet food may be moveably disposed inside the container. The method may comprise giving the pet a piece of pet food.

### BRIEF DESCRIPTION OF THE DRAWINGS

FIG. 1 is a perspective view of an exemplary pet food product.

FIG. 2 is a cross-sectional view of an exemplary rigid, metallic wall.

### DETAILED DESCRIPTION OF THE INVENTION

This application claims the benefit of U.S. Provisional Application Ser. No. 61/666,139, which is hereby incorporated by reference in its entirety.

As used herein, “diet” or “routine diet” refers to a food product provided to an animal as the primary or sole source of nutrition. A diet or routine diet may be nutritionally balanced, meaning that the diet provides all of a typical animal's nutritional needs when fed according to feeding guidelines for that diet, or according to common usage, if no feeding guidelines are provided. Such nutritional needs are described, for example, in Nutrient Profiles for dogs and cats published by the Association of American Feed Control Officials (AAFCO).

As used herein, “dry” refers to a food product having a moisture content less than about 12%, by weight, or from 6% to 12%, by weight.

As used herein, “semi-moist” refers to a food product having a moisture content between 12% and 40%, by weight.

As used herein, “food” refers to any composition intended for oral ingestion, and excludes items which are capable of being swallowed but are generally considered inedible, such as rocks or toys made of inedible polymers like PVC, modified PVC, or vinyl, whether swallowed whole or broken and swallowed in pieces.

As used herein, “pet” refers to a companion animal, such as a cat or a dog. “Pet” may also refer to other domesticated animals having like nutritional needs to cats or dogs.

As used herein, “treat” refers to a food product which is not nutritionally balanced and is not intended to serve as a routine diet. A treat may have a desirable taste or texture, and may be in the form of a biscuit, chew, cookie, morsel, and the like.

As used herein, “supplement” refers to a food product which is not nutritionally balanced and is not intended to serve as a routine diet. A supplement may provide a nutrient or nutrient(s) to supplement a routine diet. For example, a supplement may provide probiotics, prebiotics, minerals, cinnamon, vitamins, herbs or plant extracts, or other substances intended to promote health or wellness. A supplement may also be a treat.

With regard to human food, it has been said that you eat with your eyes first. High cuisine frequently features elaborate visual presentations that may have no direct effect on the objective taste of the food, but may nonetheless make a meal more appealing or more enjoyable. In sharp contrast, pet foods are often designed primarily for functionality. Even pet treats may have extended shelf-lives and low- or no-mess packaging. Design for pet experience has focused primarily on palatants and textures to make pet food taste better. There remains an opportunity to improve the dining or feeding experience of a companion animal. The feeding experience includes both the appreciation or enjoyment of the food, and also the interaction related to the food, as between a pet and the pet's caretaker.

In some embodiments, a pet food is packaged in a container defined by walls between the interior of the container and the exterior of the container. The container may comprise at least one rigid, metallic wall. When the container is shaken, the pet food may strike the rigid, metallic wall, causing a “drum-like” phenomenon to occur, which may produce an auditory stimulus which is appealing to many pets. The metallic wall may comprise any suitable metal or alloy, including aluminum, tin, chromium, stainless steel, copper, iron (including cast iron), brass, pewter, silver, bronze, or combinations thereof. The rigid, metallic wall may be substantially flat (e.g., having no concavity or convexity), excluding any lip or other fitment for joining the wall to the rest of the container. The rigid, metallic wall may have a thickness, from the interior of the container to the exterior of the container, of 0.10 mm to 0.30 mm. If the thickness of the rigid, metallic wall varies, the average thickness may be from 0.10 mm to 0.30 mm.

The other walls of the container may be rigid or flexible, and may be of metallic or non-metallic materials. For example, the walls of the container may comprise paper, paperboard, cardboard, films (such as cellophane), fabrics (such as burlap or cheesecloth), polymers (such as polypropylene, polyethylene, polyvinylchloride, or polyethyleneterepthalate), foils (such as aluminum foil), or combinations, layers, or laminates thereof. In one embodiment, the non-metallic side walls comprise a fiber composite as described in U.S. Pat. No. 3,498,798, including as layers listed from the inside of the container sidewall to the outside of the container sidewall:

| | Approximate basis weight |
|---|---|
| Component: | (lb./3000 sq. ft.) |
| Polypropylene (0.001 inch) | 15 |
| Adhesive | 1 |
| Aluminum foil (0.00035 inch) | 14 |
| Polyethylene (0.0005 inch) | 8 |
| Kraft paper | 30 |
| Adhesive | 1 |
| Kraft board (0.012 inch) | 126 |
| Adhesive | 1 |
| Kraft board (0.012 inch) | 126 |
| Total | 322 |

The fiber composite material described includes aluminum foil in amounts which generally provide sufficient protection for the pet food from moisture and oxygen transmission through the container walls. However, if desired, any or all of the walls of the container may further comprise a laminate, layer, or coating to increase the moisture, oxygen, or chemical resistance of the wall material. Increased chemical resistance may be desirable, for example, if the pet food comprises acidic palatants or coating materials which could, for example, degrade the physical or barrier properties of, or leach components from, the wall material.

In some embodiments, the container comprises top and bottom walls. The top and bottom walls may comprise different materials, or may be shaped, positioned, or structured, to provide different acoustic properties when struck by pet food pieces. In some embodiments, the container produces an alternating sound when shaken, as pet food strikes the top and bottom walls. An alternating sound may provide a distinct and/or appealing sound, which may be associated with a treat or reward by a pet. In one embodiment, at least one of the top wall and the bottom wall comprises a metal or alloy, such as aluminum, tin, chromium, stainless steel, copper, iron (including cast iron), brass, pewter, silver, bronze, or combinations thereof. In some embodiments, neither the top wall nor the bottom wall comprise a metal or alloy.

The container may be of any desired cross-sectional shape, such as circular, square, rectangular, triangular, pentagonal, hexagonal, and the like. The container may have an irregular cross-section shape, such as a dog-bone or star shape. If an irregular cross-section is used, the dimensions of the shape may be selected with consideration of the pet food shape and dimension, to ensure that the pet food can move easily within the container when it is shaken. In one embodiment, the container has a cylindrical shape with a rigid, metallic wall at one or both ends of the cylinder. In some embodiments, only one container wall is rigid and metallic. By using only one rigid, metallic wall, the sharp, attention-grabbing noise created by shaking the container may be moderated, which might be useful, for example, if the pet food is intended for a shy or easily startled animal. In some embodiments, the rigid, metallic wall is reversibly removable from the package, as if the rigid, metallic wall is a closure, such as a top or seal. In some embodiments, the rigid, metallic wall is not reversibly removable from the container. For example, the rigid, metallic wall may not be removable from the container (e.g., may be integral with the container, or may be attached in such a way that it is not easily removed without tools or destroying the container). As another example, the rigid, metallic wall may be removable from the container without being amenable to replacement on or in the container, as if the rigid, metallic wall is removed and thrown away. For example, the rigid, metallic wall may be a peel-back seal for the container that is pulled partially or completely away from the container to access the pet food inside, and is not restored to its original position or function.

In some embodiments, the pet food may occupy no more than 60%, or 50%, or even 45% of the volume of the container, so that the pet food can move freely when the canister is shaken. This volume is measured as actual, rather than bulk, volume. In some embodiments, the pet food may occupy no less than 40% of the volume of the container. The pet food in the container may be dry or semi-moist. The pet food may be a diet, a treat, or a supplement. If the pet food is a diet, the pet food may be nutritionally balanced and meet all nutrient requirements. If the pet food is a diet, the container may comprise a single meal, or a single day's allotment of food, or a small number of meals or days of food, such as 2, 3, 4, or 5 meals or days' worth of meals.

The pet food may be in distinct pieces. The container may hold at least two distinct pieces of the pet food. The pet food pieces may be moveably disposed inside the container. The pieces may be such that the largest linear dimension of the pet food is smaller than the smallest linear dimension of the container. The pieces may be such that the largest linear dimension of the pet food is less than two-thirds, or less than one-half, or less than one-third, of the smallest linear dimension of the container. The pieces may be such that the largest linear dimension of the pet food is at least one-fifth, or at least one-fourth, of the smallest linear dimension of the container. The largest linear dimension of the pet food is the diameter of the smallest sphere that circumscribes the entire treat, i.e., with no part of the treat outside of the sphere. If the pieces are not uniform in size or shape, then the largest linear dimension is taken from the largest type of piece in the container. The smallest linear dimension of the container is the diameter of the largest circle that can be drawn within the cross-sectional interior of the container without overlapping the interior surface of any container wall.

The container may be filled with pet food to leave at least 2.5 cm of headspace at the top of the container, or at least 1.3 cm of headspace at the top of the container, or between about 1.3 cm and about 2.5 cm of headspace at the top of the container.

The pet food may be shaped in any desired shape, such as spheres, cubes, cuboids, or 3-D shapes having one or more faces shaped, for example, like meats (e.g., a turkey leg, lamb chop, T-bone steak, bacon, or ham), vegetables (e.g., carrots, corn, broccoli, or zucchini), fruits (e.g., apples, pears, or berries), nuts (e.g., peanuts), bones (e.g., stylized “dog bones”), stars, crosses, ovals, pentagons, hexagons, squares, circles, and the like, or combinations thereof. The pet food may comprise colors, either natural or artificial, that may be appealing to pets or their caretakers. For example, the pet food may comprise tomatoes, carrots, blueberries, or other foods that may contribute bright, natural colors to the food. The pet food may comprise palatants, aromas, or flavorings to make the food more appealing to pets or their caretakers. For example, the pet food may comprise herbs, such as parsley, rosemary, thyme, oregano, sage, or the like, or combinations thereof, to provide aroma and/or flavor that may be appealing.

The pet food may be resistant to breakage. A pet food is resistant to breakage if, when individual pieces of pet food are dropped from a height of 1.2 meters onto a linoleum-covered hard surface, such as a floor, less than or equal to 20% of the pieces break into 3 or more smaller pieces. The pet food may have a water activity, Aw, less than 0.3, or less than 0.2. As used herein, “Aw” or “water activity” is a measure of the free or unassociated water in a product, and is measured by dividing the vapor pressure of water in the headspace above a product or composition by the vapor pressure of pure (distilled) water at room temperature (22° C.±2° C.). Pure distilled water has an Aw of one.

The pet food may comprise functional nutritional additives to recover, maintain, or improve the health of the pet. For example, the pet food may comprise prebiotics (such as oligosaccharides, including fructooligosaccharides), probiotics, bacteriophages, dental plaque preventatives or removers, mannoheptulose, antioxidants, caloric restriction mimetics, polyphenols, isoflavones, and the like.

In some embodiments, the sound produced by shaking the container may attract a pet's attention, or summon a pet. A method for attracting a pet's attention or summoning a pet may comprise shaking a container comprising at least one rigid, metallic wall and a pet food. The shaking may produce an auditory stimulus. The auditory stimulus may become associated with the food inside the container, and may, therefore, become a useful training tool. For example, shaking the container may be used in a manner similar to “clicker training,” where the sound of a device, generally a thin metal or polymeric plate which is reversibly deformed and released to produce an audible vibration, is associated with food as a reward for desired behavior. Generally in clicker training, the food is gradually phased out in favor of the clicker. However, the auditory stimulus of a pet food striking a rigid metal wall may make a similar noise, and, therefore, may provide a suitable introduction to clicker training while also avoiding the need for the trainer to manage both the clicker and a separate container of treats.

A method for using auditory stimulus to reinforce desired behavior in a pet animal may comprise inducing or observing a desired behavior. The method may comprise shaking a container comprising at least one rigid, metallic wall and a pet food. The shaking of the container may occur in close temporal proximity to the induction or observation of the desired behavior, for example, within 1 minute, or within 30 seconds, or with 10 seconds, of the desired behavior. Simultaneous with or immediately following the shaking of the container, a piece of pet food, such as a treat or a kibble, may be given to the pet animal. The pet food may be from the container comprising at least one rigid, metallic wall.

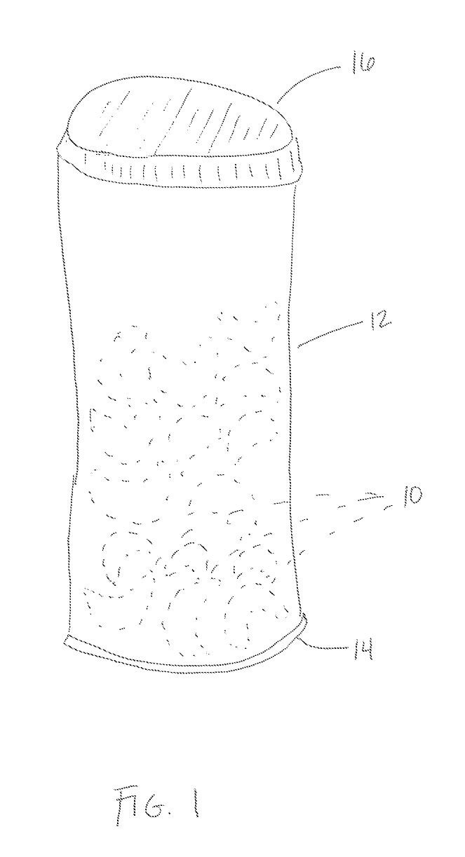

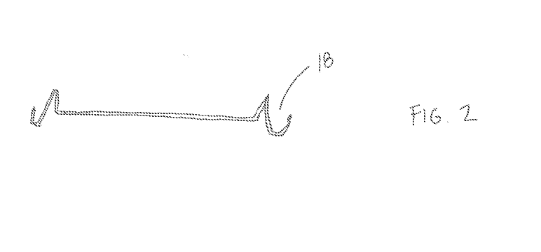

FIG. 1 shows an exemplary, non-limiting embodiment of a pet food with auditory stimulus as described. Pet food 10 is shown inside container 12, which is generally shaped like a cylinder. Container 12 comprises rigid, metallic wall 14, which, in the embodiment of FIG. 1, is the bottom surface of container 12. Container 12 further comprises a top surface, shown with a cap 16. Cap 16 may serve as a second rigid, metallic wall, or may be of any other suitable material, such as polymers, paperboard, films, foils, and the like. As shown in FIG. 1, the orientation of pet food 10 inside container 12 is generally not critical, and may change as the product settles after being filled into container 12 during manufacture, and, of course, may change if container 12 is shaken. FIG. 2 is a cross-section of rigid, metallic wall 14 from FIG. 1, showing a lip or ridge 18, which may be used to integrate or join rigid, metallic wall 14 to container 12, as by a mechanical press-fit.

### Example 1

A container as shown in FIG. 1 is constructed of a cylinder of fiber composite material and a steel bottom, with a polymer film seal at the top of the cylinder which is covered by a reversibly removable polymer lid. The cylinder has an inner diameter of approximately 7.4 cm. The container is filled with a soft, moist pet treat having a largest linear dimension of about 3.8 cm, to within 2.54 cm of where the polymer film seal will be placed (e.g., to provide a headspace of about 2.54 cm). When closed and shaken, the container provides a unique, metallic, ring-y noise that is a curiosity to dogs and may be quickly associated with the treats inside the container.

It is, of course, possible to obtain a “drum-like” phenomenon without the use of a rigid, metallic wall. An animal or synthetic skin, such as skins made of polyester, Mylar, or Kevlar, may be stretched taut across an opening or a portion of an open space in a container where particles, such as pet food, inside the container may strike the skin. The pitch of the noise made can be modified by varying the tautness of the skin across the opening, with increased tautness generally associated with a rise in pitch, and decreased tautness generally associated with a decrease in pitch. Skin-based drums, as compared to the use of a rigid, metallic wall, may be preferred for aesthetic reasons. In some embodiments, a container having an adjustable pitch strike surface, such as a skin with adjustable tautness, may be used to acclimate a shy or fearful pet to the atypical noise of a clicker or a container comprising a rigid, metallic wall. An array of two or more containers comprising pet food, each of the containers providing different acoustic properties, may be provided, with loudness and/or pitch characteristics differing in different packages to appeal to different pets and/or different caretakers.

In some embodiments, the container may comprise an optional sound producing device. The sound producing device may provide a more consistent auditory stimulus, for example, as the contents of the container are depleted. The sound producing device may be integral to the container, or could be reversibly or irreversibly joined to the container. In some embodiments, the sound producing device is reversibly joined to the container, such that the sound producing device can be joined to a first container, removed from the first container, and joined to a second container, as, for example, when the contents of the first container are depleted.

A sound producing device, if used, may produce sound by relying on the dynamic forces applied to the container during shaking. For example, the sound producing device may be or comprise a whistle, bell, rattle, or combination thereof. The sound producing device may use an energy source separate from the dynamic forces applied to the container during shaking. In some embodiments, the energy source is a battery. The sound producing device may be adapted to work in conjunction with the container. The sound producing device may be activated by pressing a button as the container is grasped. The button may produce a pre-recorded or electronically generated sound through a speaker. In some embodiments, a user may select one of a variety of sounds, including, in some embodiments, custom sounds, to be made by the sound producing device. In some embodiments, a user may record a sound for playback on actuation of the sound producing device. In some embodiments, the sound producing device is activated by holding the container in a hand, such that the skin from the hand closes a circuit between two exposed electrical conductors. Sound producing devices which can operate without shaking the container, e.g., battery-operated devices, may be helpful for pet caretakers who have difficulty energetically shaking the container, or simply do not wish to energetically shake the container.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pet food product comprising:
a container comprising at least one rigid, metallic wall; and
two or more distinct pieces of pet food moveably disposed inside the container.

2. The pet food product of claim 1, wherein the container comprises at least two rigid, metallic walls.

3. The pet food product of claim 1, wherein the container comprises exactly one rigid, metallic wall.

4. The pet food product of claim 1, wherein the rigid, metallic wall is integral to the container.

5. The pet food product of claim 1, wherein the rigid, metallic wall is reversibly removable from the container.

6. The pet food product of claim 1, wherein the rigid, metallic wall is irreversibly removable from the container.

7. The pet food product of claim 1, wherein the pet food is a treat or supplement.

8. The pet food product of claim 1, wherein the pet food is a nutritionally balanced diet.

9. The pet food product of claim 7, wherein the container comprises approximately 1 meal's worth of pet food.

10. The pet food product of claim 1, wherein the pet food is semi-moist.

11. The pet food product of claim 1, wherein the pet food is dry.

12. The pet food product of claim 1, wherein the pet food occupies no more than 60% of the volume of the container.

13. The pet food product of claim 1, wherein the pet food comprises parsley, rosemary, thyme, oregano, sage, or combinations thereof.

14. The pet food product of claim 1, wherein the pet food comprises a prebiotic, a probiotic, a bacteriophage, a dental plaque preventative, mannoheptulose, an antioxidant, a caloric restriction mimetic, a polyphenol, an isoflavone, or a combination thereof.

15. The pet food product of claim 14, wherein the pet food comprises an oligosaccharide.

16. The pet food product of claim 1, wherein the pet food is filled into the container to leave at least 1.3 cm of headspace at the top of the container.

17. The pet food product of claim 1, wherein the rigid, metallic wall comprises a material selected from the group consisting of aluminum, tin, chromium, steel, copper, iron, brass, pewter, silver, bronze, and combinations thereof.

18. A method of attracting a pet's attention, the method comprising shaking the pet food product of claim 1.

19. A method of summoning a pet, the method comprising shaking the pet food product of claim 1.

20. A method of training a pet, the method comprising:
inducing or observing a desired pet behavior;
shaking the pet food product of claim 1 in close temporal proximity to the induction or observation of the desired pet behavior; and
giving the pet a piece of the pet food.
